(19) United States
(12) Patent Application Publication
(10) Pub. No.: US 2022/0036393 A1
(43) Pub. Date: Feb. 3, 2022

(54) SYSTEM AND METHOD FOR PROVIDING A FOOD TRUCK FINDER

(71) Applicant: P AND D 1091, LLC, West Palm Beach, FL (US)

(72) Inventors: Paisley Coats Monroe, Easton, CT (US); Daniel Geary Monroe, Easton, CT (US)

(73) Assignee: P AND D 1091, LLC, West Palm Beach, FL (US)

(21) Appl. No.: 17/390,112

(22) Filed: Jul. 30, 2021

Related U.S. Application Data
(60) Provisional application No. 63/058,748, filed on Jul. 30, 2020.

(51) Int. Cl. G06Q 30/02; G06Q 10/02; G06Q 30/06; H04W 64/00

(52) U.S. Cl. CPC G06Q 30/0206; G06Q 10/02; H04W 64/003; H04W 64/006; G06Q 30/0631

(57) ABSTRACT

A system and method for providing and utilizing a food truck finder are disclosed. The food truck finder may comprise a software application that provides a food truck locator service that enables customers accessing the software application to view the locations of various food truck options in real time on a digital map. The food truck finder may enable a customer to access a food truck profile of the food truck options, which may include menus, feedback associated with the food truck option, food availability, weather conditions, and other information associated with the food truck option. A consumer may order a service or product from a food truck option and may be provided various incentives based on the order. The food truck finder may also provide future locations for a food truck associated with a food truck option so that the consumer may plan accordingly.

### CROSS-REFERENCE TO RELATED APPLICATIONS

This application claims priority to and the benefit of U.S. Provisional Application No. 63/058,748, filed on Jul. 30, 2020, the disclosure of which is hereby incorporated by reference in its entirety.

### FIELD OF THE INVENTION

The present application relates to location technologies, operations management technologies, food ordering technologies, vehicle technologies, and computing technologies, and more particularly, to a system and method for providing a food truck finder.

### BACKGROUND

In today's society, people seek to have a variety of dining options and enjoy having a variety of different channels in which they can experience such dining options. For example, a person is able to enjoy going to a sit-down restaurant, order food directly from a restaurant for pick up, order food directly from a restaurant to be delivered to the person, order food from a food service application for pickup or delivery, or even prepare his or her own food at home. As technology has advanced over the past few years, people are now able to enjoy various types of food options from different geographical areas that they would not have readily been able to enjoy without such technology advancements. For example, various software applications exist that enable people to quickly view different types of cuisines and menus of food vendors from the convenience of their mobile devices. Such applications also enable people to order food items from such vendors, track the progress of preparation and/or delivery of ordered food items, and leave reviews for the vendors.

Despite the foregoing, existing technologies and processes have not been well-adapted for the food truck and mobile food industries. Therefore, current technologies and processes may be modified and improved so as to provide enhanced functionality and features that will enable people to more readily and conveniently enjoy food truck and mobile food options in addition to traditional food options. Such enhancements and improvements may provide for improved user satisfaction, increased reliability, increased accuracy, increased efficiencies, increased access to meaningful data, substantially-improved food truck engagement with customers, improved monitoring of food trucks, and increased ease-of-use for users.

### SUMMARY

A system and accompanying methods for providing and utilizing a food truck finder are disclosed. The system and methods may include providing a software application that provides a food truck locator service that enables customers accessing the software application to view the locations of various food truck options in real time on a digital map rendered in a graphical user interface of the software application. In certain embodiments, the system and methods may enable a customer to access food truck profiles of the food truck options. Such food truck profiles may include any information associated with a food truck option, such as, but not limited to, menus, feedback associated with the food truck option, food availability, weather conditions, supply and demand metrics, food wait times, bundle deals, and other information associated with the food truck option. The system and methods may enable a customer to order a service or product from a food truck option and may also provide future locations for a food truck associated with a food truck option so that the consumer may plan future dining experiences accordingly.

In certain embodiments, the system and methods may enable a customer to book a food truck vehicle and associated food services corresponding to a food truck option for a period of time and/or for an event. For example, the system and methods may enable a customer to book a food truck for a wedding, a graduation, a birthday party, or any other desired event. The system and methods may also enable customers to track the preparation of ordered food items ordered via the application and track their own location relative to the associated food truck's location in real time. Additionally, the system and methods may enable a user to pick up their ordered items from the food truck and leave feedback relating to their experience and/or the ordered items via the application. In certain embodiments, based on a customer's ordering from a particular food truck option, the system and methods may offer various incentives to the customers for the current order, for future orders, and/or for being a loyal customer. In certain embodiments, the system and methods may allow the customers to generate their own profiles within the application. Data associated with the customers' interactions with the application and the various businesses associated with the food truck options may be stored and analyzed as well. Over time, the analyzed data may be utilized by the systems and methods to adjust the experience that the customers have with the various food truck options and with the application itself. Notably, the system and methods provide enhancements to various existing technologies and facilitate interactions between food truck or other businesses and their customers in a manner that is more efficient, easy-to-use, informative, and effective when compared to existing technologies.

To that end, in one embodiment according to the present disclosure, a system for providing and utilizing a food truck finder is disclosed. The system may include a memory that stores instructions and a processor that executes the instructions to perform the various operations of the system. The system may perform an operation that includes providing an application for providing one or more food truck options that may be rendered via a graphical user interface of the application. Additionally, the system may perform an operation that includes providing, via the application, the locations of the vehicles associated with the food truck options to a customer device accessing the application. In certain embodiments, the locations of each vehicle may be provided via a global positioning sensor in proximity to the vehicle, such as in a global positioning sensor of the vehicle itself, a global positioning sensor of a person(s) in or in proximity to the vehicle, and/or a global positioning sensor of another device in proximity to the vehicle. In certain embodiments, other types of devices may be utilized to provide the location. For example, transceivers, cellular chips, short-range wireless chips, IoT devices, and/or other devices may be utilized to provide the location. In certain embodiments, a person associated with a vehicle of a food truck option may transmit the location such as by typing in the location into the application, speaking the location into the application, and/or through other methodologies. The system may proceed to perform an operation that includes displaying, via the graphical user interface of the application, the locations of each vehicle associated with the food truck options on a digital map. The system may also proceed to perform an operation that includes enabling the customer device to access food truck profiles of the food truck options that include content associated with each respective food truck option.

In another embodiment, a method for providing and utilizing a food truck finder is disclosed. The method may include utilizing a memory that stores instructions, and a processor that executes the instructions to perform the various functions of the method. In certain embodiments, the memory and processor may be components of a food truck vehicle, a consumer device, another device, or a combination thereof. In particular, the method may include providing one or more food truck options via a graphical user interface of an application that may be made accessible to a customer device of a customer. Additionally, the method may include providing, via the application, a location of each vehicle associated with the food truck options to the customer device accessing the application. In certain embodiments, the locations of each vehicle may be provided via the vehicles themselves and/or via a device in proximity to the vehicle. For example, the locations may be provided via a global positioning sensor of the vehicle itself, a global positioning sensor of a person(s) in or in proximity to the vehicle, a global positioning sensor of another device in proximity to the vehicle, a transceiver of the vehicle, a transceiver of another device in proximity to the vehicle, cellular chips, any other device, or a combination thereof. The method may further include displaying, via the graphical user interface of the application, the locations of the vehicles associated with the food truck options on a map, such as relative to the current location of a customer associated with the customer device. Moreover, the method may include enabling the customer device to access food truck profiles of the food truck options that include content associated with the food truck options.

According to yet another embodiment, a computer-readable device having instructions for providing and utilizing a food truck finder is provided. The computer instructions, which when loaded and executed by a processor, may cause the processor to perform operations including: providing a food truck option via a graphical user interface of an application; providing, via the application, a location of a vehicle associated with the food truck option to a customer device accessing the application, wherein the location of the vehicle is provided via a global positioning sensor in proximity to the vehicle; displaying, via the graphical user interface, the location of the vehicle associated with the food truck option on a map where locations of other vehicles associated with other food truck options are displayed; and enabling the customer device to access a food truck profile of the food truck option that includes content associated with the food truck option.

These and other features of the systems and methods for providing and utilizing a food truck finder are described in the following detailed description, drawings, and appended claims.

### BRIEF DESCRIPTION OF THE DRAWINGS

FIG. 1 is a schematic diagram of a system for providing and operating a food truck finder according to an embodiment of the present disclosure.

FIG. 2 is a flow diagram illustrating a sample method for providing and operating a food truck finder according to an embodiment of the present disclosure.

FIG. 3 is a schematic diagram of a machine in the form of a computer system within which a set of instructions, when executed, may cause the machine to perform any one or more of the methodologies or operations of the systems and methods for providing and utilizing a food truck finder.

### DETAILED DESCRIPTION OF THE INVENTION

A system 100 and accompanying methods for providing and utilizing a food truck finder are disclosed. The system 100 and methods may include providing a software application that provides a food truck locator service that enables customers accessing the software application to view the locations of various food truck options in real time on a digital map rendered in a graphical user interface of the software application. Additionally, the system and methods may enable a customer to access food truck profiles of the food truck options. Such food truck profiles may include any information associated with a business associated with a food truck option, such as, but not limited to, menus, feedback associated with the food truck option, food availability, weather conditions, supply and demand metrics for the business and/or the food truck itself, food wait times, potential bundle deals, and other information associated with the food truck option. The system 100 and methods may enable a customer to order a service or product from a business associated with a food truck option and may also provide future locations for a food truck associated with the food truck option so that the consumer may plan future dining experiences accordingly.

In certain embodiments, the system 100 and methods may enable a customer to book a food truck vehicle and associated food services for a period of time and/or for an event. For example, the system 100 and methods may enable a customer to book a food truck for a wedding, a graduation, a birthday party, and/or any other desired event. The system 100 and methods may also enable customers to track the preparation of ordered food items and/or services ordered via the application and also track their own location relative to the associated food truck's location in real time. Additionally, the system 100 and methods may enable a user to pick up their ordered items from the food truck and leave feedback and/or commentary relating to his or her experience and/or the ordered items via the application. In certain embodiments, based on a customer's ordering from a particular food truck option, the system 100 and methods may offer various incentives to the customers for the current order, for future orders, and/or for being a loyal customer. In certain embodiments, the system 100 and methods may allow the customers to generate their own profiles within the application. Data associated with the customers' interactions with the application and the various businesses associated with the food truck options may be stored and analyzed as well. Over time, the analyzed data may be utilized by the system 100 and methods to adjust the experience that the customers have with the various food truck options and with the application itself. Notably, the system 100 and methods provide enhancements to various existing technologies and facilitate interactions between food truck or other businesses and their customers in a manner that is more efficient, easy-to-use, informative, and effective when compared to existing technologies.

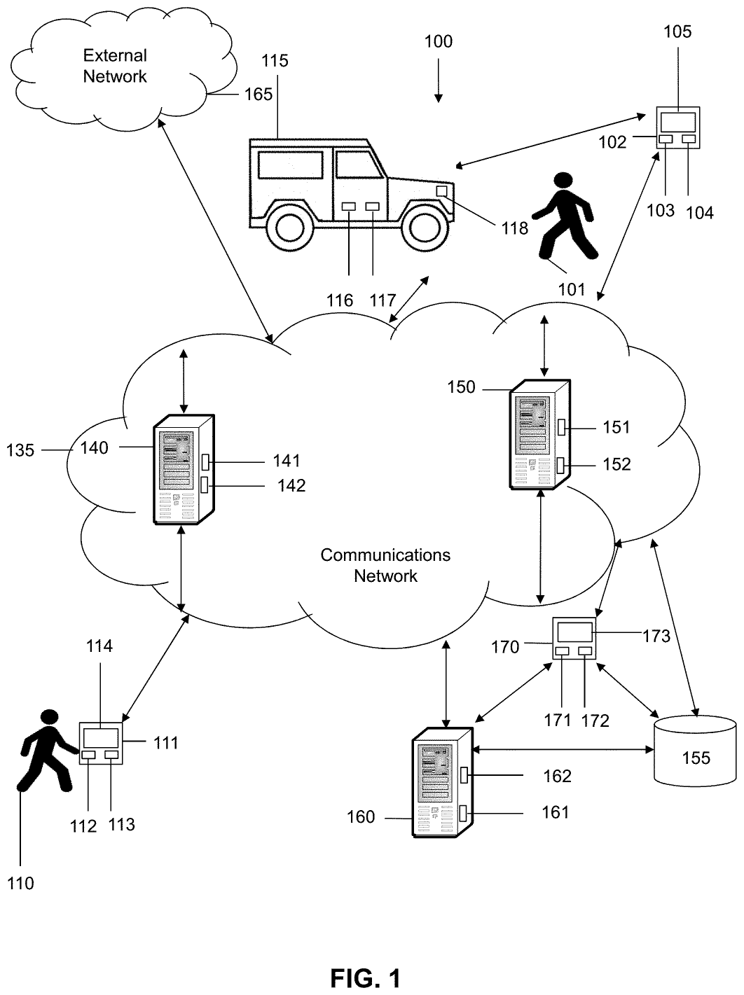

As shown in FIGS. 1-3, a system 100 and method for providing and utilizing a food truck finder are disclosed. The system 100 may be configured to support, but is not limited to supporting, data and content services, data aggregation applications and services, food and food ordering applications and services, food truck applications and services, mobile device applications and services, operations management applications and services, simulation technologies, gaming technologies, big data technologies, computing applications and services, cloud computing services, internet services, satellite services, telephone services, software as a service (SaaS) applications, mobile applications and services, and any other computing applications and services. The system may include a first user 101, who may utilize a first user device 102 to access data, content, and applications, or to perform a variety of other tasks and functions. As an example, the first user 101 may utilize first user device 102 to access an application (e.g. a browser or a mobile application) executing on the first user device 102 that may be utilized to access web pages, data, and content associated with the system 100. In certain embodiments, the first user 101 may be any type of user that may desire to view and possibly order a variety of potential food options provided via an application of the system 100.

The first user device 102 utilized by the first user 101 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, audio device, neurotransmitter, etc.) that may enable the first user 101 to interact with various applications executing on the first user device 102, to interact with various applications executing within the system 100, and to interact with the system 100 itself. In certain embodiments, the first user device 102 may be a computer, a laptop, a tablet device, a phablet, a server, a mobile device, a smartphone, a smart watch, and/or any other type of computing device. Illustratively, the first user device 102 is shown as a mobile device in FIG. 1. The first user device 102 may also include a global positioning system (GPS), which may include a GPS receiver and any other necessary components for enabling GPS functionality, accelerometers, gyroscopes, sensors, and any other componentry suitable for a mobile device.

In addition to the first user 101, the system 100 may include a second user 110, who may utilize a second user device 111 to access data, content, and applications, or to perform a variety of other tasks and functions. As with the first user 101, the second user 110 may be a user that may be a potential customer of a food truck or even a food truck operator. Much like the first user 101, the second user 110 may utilize second user device 111 to access an application (e.g. a browser or a mobile application) executing on the second user device 111 that may be utilized to access web pages, data, and content associated with the system 100. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. a screen, a monitor, a graphical user interface, etc.) that may enable the second user 110 to interact with various applications executing on the second user device 111, to interact with various applications executing in the system 100, and to interact with the system 100. In certain embodiments, the second user device 111 may be a computer, a laptop, a tablet device, a phablet, a server, a mobile device, a smartphone, a smart watch, and/or any other type of computing device. Illustratively, the second user device 111 may be a computing device in FIG. 1. The second user device 111 may also include a GPS, which may include a GPS receiver and any other necessary components for enabling GPS functionality, accelerometers, gyroscopes, sensors, and any other componentry suitable for a mobile device. The second user device 111 may also include any of the componentry described for first user device 102.

In certain embodiments, the first user device 102 and the second user device 111 may have any number of software applications and/or application services stored and/or accessible thereon. For example, the first and second user devices 102, 111 may include food applications, food ordering applications, operations management applications, restaurant applications, food tracking applications, vehicle tracking applications, location tracking applications, applications for analyzing and interpreting sensor data, artificial intelligence applications, machine learning applications, big data applications, applications for analyzing data, applications for synthesizing data, applications for integrating data, cloud-based applications, search engine applications, natural language processing applications, database applications, algorithmic applications, phone-based applications, product-ordering applications, business applications, e-commerce applications, media streaming applications, content-based applications, database applications, gaming applications, internet-based applications, browser applications, mobile applications, service-based applications, productivity applications, video applications, music applications, social media applications, presentation applications, any other type of applications, any types of application services, or a combination thereof In certain embodiments, the software applications and services may include one or more graphical user interfaces so as to enable the first and second users 101, 110 to readily interact with the software applications.

The software applications and services may also be utilized by the first and second users 101, 110 to interact with any device in the system 100, any network in the system 100, or any combination thereof. For example, the software applications executing on the first and second user devices 102, 111 may be applications for receiving data, applications for storing data, applications for determining activities that the first and/or second users 101, 110 are suited for, applications for determining actions performed by the first and/or second users 101, 110, applications for receiving demographic and preference information, applications for transforming data, applications for executing mathematical algorithms, applications for generating and transmitting electronic messages, applications for generating and transmitting various types of content, any other type of applications, or a combination thereof. In certain embodiments, the first and second user devices 102, 111 may include associated telephone numbers, internet protocol addresses, device identities, or any other identifiers to uniquely identify the first and second user devices 102, 111 and/or the first and second users 101, 110. In certain embodiments, location information corresponding to the first and second user devices 102, 111 may be obtained based on the internet protocol addresses, by receiving a signal from the first and second user devices 102, 111, or based on profile information corresponding to the first and second user devices 102, 111.

The system 100 may also include a communications network 135. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry, and may be controlled by a service provider. The communications network 135 may also include and be connected to a cloud-computing network, a phone network, a wireless network, an Ethernet network, a satellite network, a broadband network, a cellular network, a private network, a cable network, the Internet, an internet protocol network, a content distribution network, any network, or any combination thereof. Illustratively, server 140 and server 150 are shown as being included within communications network 135.

Notably, the functionality of the system 100 may be supported and executed by using any combination of the servers 140, 150, and 160. The servers 140, and 150 may reside in communications network 135, however, in certain embodiments, the servers 140, 150 may reside outside communications network 135. The servers 140, and 150 may be utilized to perform the various operations and functions provided by the system 100, such as those requested by applications executing on the first and second user devices 102, 111. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 150 may include a memory 151 that includes instructions, and a processor 152 that executes the instructions from the memory 151 to perform the various operations that are performed by the server 150. In certain embodiments, the servers 140, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 150 may be communicatively linked to the communications network 135, any network, any device in the system 100, or any combination thereof.

The database 155 of the system 100 may be utilized to store and relay information that traverses the system 100, cache information and/or content that traverses the system 100, store data about each of the devices in the system 100, and perform any other typical functions of a database. In certain embodiments, the database 155 may store the output from any operation performed by the system 100, operations performed and/or outputted by the vehicle 115 and/or components of the vehicle, operations performed and/or outputted by any component, program, process, device, network of the system 100, or any combination thereof. For example, the database 155 may store data from the vehicle 115, data from the first and/or second user devices 102, 111, location data provided by any devices and/or components of the system 100, any other data, or a combination thereof. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or be connected to a processor and memory to perform the various operations associated with the database 155. In certain embodiments, the database 155 may be connected to the servers 140, 150, 160, the first user device 102, the second user device 111, the vehicle 115, any devices in the system 100, any other device, any network, or any combination thereof.

The database 155 may also store information obtained from the system 100, store information associated with the first and second users 101, 110, store location information for the first and second user devices 102, 111 and/or first and second users 101, 110, store user profiles associated with the first and second users 101, 110, store device profiles associated with any device in the system 100, store communications traversing the system 100, store user preferences, store demographic information for the first and second users 101, 110, store information associated with any device or signal in the system 100, store information relating to usage of applications accessed by the first and second user devices 102, 111, store any information obtained from any of the networks in the system 100, store historical data associated with the first and second users 101, 110, store device characteristics, store information relating to any devices associated with the first and second users 101, 110, or any combination thereof. The database 155 may also store any information associated with menus, pricing information for services and/or products, orders, receipts, records of purchase history for customers, demand information for products and services provided by a food truck, booking information for a food truck, a history of locations of a food truck and/or customers ordering from the food truck, preferences of customers, availability of food items, any other information, or a combination thereof. The database 155 may store algorithms for facilitating operation of the application for the food truck finder, algorithms for calculating food wait times, algorithms for calculating demand for food truck services, algorithms for determining locations of food trucks with respect to other food trucks and/or customers, any other algorithms for performing any other calculations and/or operations in the system 100, or any combination thereof. In certain embodiments, the database 155 may be configured to store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

The system 100 may also include a software application, which may be configured to perform and support the operative functions of the system 100 and/or the food truck finder. In certain embodiments, the application may be a website, a mobile application, a software application, or a combination thereof, which may be made accessible to users utilizing one or more computing devices, such as first user device 102 and second user device 111. In certain embodiments, the application of the system 100 may be accessible via an internet connection established with a browser program executing on the first or second user devices 102, 111, a mobile application executing on the first or second user devices 102, 111, or through other suitable means. Additionally, the application may allow users and computing devices to create accounts with the application and sign-in to the created accounts with authenticating username and password log-in combinations. The application may include a custom graphical user interface that the first user 101 or second user 110 may interact with by utilizing a web browser executing on the first user device 102 or second user device 111. In certain embodiments, the software application may execute directly as an installed program (e.g. a mobile or local application) on the first and/or second user devices 102, 111, the computer 260, the servers 140, 150, 160, and/or the vehicle 115.

The software application may include multiple programs and/or functions that execute within the software application and/or are accessible by the software application. For example, the software application may include an application that generates web content, pages, and/or data that may be accessible to the first and/or second user devices 102, 111, the database 155, the external network 165, any type of program, any device and/or component of the system 100, or any combination thereof. The application may provide application content and pages and may be configured to generate a graphical user interface and/or other types of interfaces for the software application that is accessible and viewable by the first and second users 101, 110 when the software application is loaded and executed on the vehicle 115, a device in proximity to the vehicle 115, and/or the first and/or second computing devices 102, 111. The graphical user interface for the software application may display content associated food trucks (or any other desired business), any type of content, or any combination thereof. For example, the graphical user interface may display a listing of various food truck options that a user may be interested in, food truck profiles associated with each food truck option, location data for each food truck, location data for users, supply and demand information for each food truck, schedules of operation for each food truck, any information associated with the operations of the food truck, or a combination thereof. The food truck profiles may include, but are not limited to, menus, pricing information, ordering information, hours of operation, user reviews, booking times, a listing of bookings, Additionally, the graphical user interface may display functionality provided by the software application that enables the first and/or second users 101, 110 and/or the first user device and/or second user device 111 to interact with features implemented by the software application.

The system 100 may also include an external network 165. The external network 165 of the system 100 may be configured to link each of the devices in the system 100 to one another. For example, the external network 165 may be utilized by the first user device 102 to connect with other devices within or outside communications network 135. Additionally, the external network 165 may be configured to transmit, generate, and receive any information and data traversing the system 100. In certain embodiments, the external network 165 may include any number of servers, databases, or other componentry, and may be controlled by a service provider. The external network 165 may also include and be connected to a cloud-computing network, a phone network, a wireless network, an Ethernet network, a satellite network, a broadband network, a cellular network, a private network, a cable network, the Internet, an internet protocol network, a content distribution network, any network, or any combination thereof. In certain embodiments, the external network 165 may be outside the system 100 and may be configured to perform various functionality provided by the system 100, such as if the system 100 is overloaded and/or needs additional processing resources.

The system 100 may also include vehicle 115, which may be a food truck, a food car, any type of vehicle, or combination thereof. In certain embodiments, the vehicle 115 may include a memory 116 that stores instructions and a processor 117 that executes the instructions to perform the various operations of the vehicle. The memory 116 and process 117 may be software, hardware, or a combination of hardware and software. In certain embodiments, the memory 116 and the processor 117 may be in a computing device that is in, on, or in proximity to the vehicle 115. For example, in certain embodiments, the computing device may be a smartphone that a user is using while in the vehicle 115, such as first user device 102 or second user device 111. The vehicle 115 and/or the computing device in the vehicle 115 may also include a GPS 118, which may be configured to provide the location of the vehicle 115 and/or user using the computing device in proximity to the vehicle 115. The GPS 118 may include a receiver and any other necessary components for enabling GPS functionality. The vehicle 115 and/or the computing device in proximity to the vehicle 115 may include accelerometers, gyroscopes, sensors, and/or any other componentry. In certain embodiments, the software application providing the functionality of the system 100 may operate directly on the vehicle 115 and/or the computing device in proximity to the vehicle 115. In certain embodiments, the software application providing the functionality and features of the system 100 may be configured to execute on the vehicle 115 itself and/or the computing device in proximity to the vehicle 115. The vehicle 115 and/or computing device may also have an interface that allows a user to interact with the various features and functionality of the application. The operation of the software application, vehicle 115, and/or components of the system 100 is further explained by the method 200 described below.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, providing access to a software application providing a plurality of food truck options to various customers (e.g. first user 101 and/or second user 110), displaying the food truck options via a graphical user interface, providing locations of the vehicles 115 associated with the food truck options to the customers accessing the application, displaying the locations of the vehicles on a digital map via the application, enabling the user devices to access food truck profiles of the businesses associated with the food truck options, enabling a customer to place an order for a service or product provided by a food truck option, determining and/or displaying a status of an order, providing the service and/or product ordered, enabling customers to receive incentives and/or provide feedback relating to the business associated with the food truck option, and performing any other suitable operations conducted in the system 100 or otherwise. In one embodiment, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

The system 100 may also include a remote device 170, which may include one or more processors 172 that may be configured to process any of the various functions of the system 100. The processors 172 may be software, hardware, or a combination of hardware and software. Additionally, the remote device 170 may also include a memory 171, which stores instructions that the processors 172 may execute to perform various operations of the system 100. In certain embodiments, data from the vehicle 115, the software application providing the functionality of the system 100, and/or any other component may be stored at the remote device 170, analyzed by the remote device 170, manipulated by the remote device, or a combination thereof. In certain embodiments, the remote device 170 may be configured to assist with the operations of the vehicle 115 and/or application itself.

Although FIGS. 1-3 illustrates specific example configurations of the various components of the system 100, the system 100 may include any configuration of the components, which may include using a greater or lesser number of the components. For example, the system 100 is illustratively shown as including a first user device 102, a second user device 111, a vehicle 115, a communications network 135, a server 140, a server 150, a server 160, a remote device 170, a database 155, and an external network 165. However, the system 100 may include multiple first user devices 102, multiple second user devices 111, multiple vehicles 115, multiple communications networks 135, multiple servers 140, multiple servers 150, multiple servers 160, multiple remote devices 170, multiple databases 155, multiple external networks 165, and/or any number of any of the other components inside or outside the system 100. Similarly, the system 100 may include any number of data sources, applications, systems, and/or programs. Furthermore, in certain embodiments, substantial portions of the functionality and operations of the system 100 may be performed by other networks and systems that may be connected to system 100.

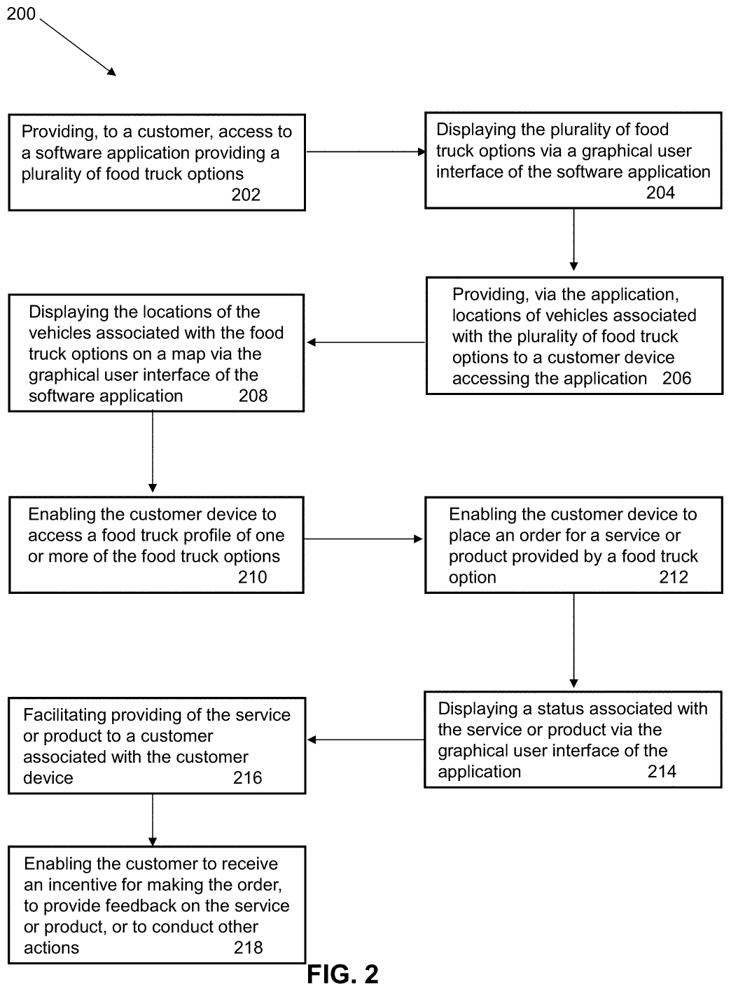

As shown in FIG. 2, an exemplary method 200 for providing and utilizing a food truck finder is schematically illustrated. Notably, in certain embodiments, any of the steps may be optional and the order of the steps may be changed as desired. The method 200 may include, at step 202, providing to a customer, access to a software application providing a plurality of food truck options. For example, the customer may be first user 101 and/or second user 110, who may download, install, or otherwise access the software application onto first and/or second user devices 102, 111. In certain embodiments, the providing of the software application may be performed and/or facilitated by utilizing the first user device 102, the second user device 111, the server 140, the server 150, the server 160, the communications network 136, the external network 165, the database 155, the vehicle 115, any appropriate program, device, network, and/or process of the system 100, or a combination thereof. At step 204, the method 200 may include displaying the plurality food truck options via a graphical user interface of the software application. For example, a listing of the various businesses associated with the food truck options and accompanying food truck profiles may be viewed and/or interacted with by the customer via the application. In certain embodiments, the displaying may be performed and/or facilitated by utilizing the first user device 102, the second user device 111, the server 140, the server 150, the server 160, the communications network 136, the external network 165, the database 155, the vehicle 115, any appropriate program, device, network, and/or process of the system 100, or a combination thereof.

At step 206, the method 200 may include providing, via the application, locations of vehicles associated with the food truck options to a customer device of a customer accessing the application. In certain embodiments, the providing may be performed and/or facilitated by utilizing the first user device 102, the second user device 111, the server 140, the server 150, the server 160, the communications network 136, the external network 165, the database 155, the vehicle 115, any appropriate program, device, network, and/or process of the system 100, or a combination thereof. At step 208, the method 200 may include displaying the locations of the vehicles associated with the food truck options on a digital map via the graphical user interface of the software application. For example, the locations of each food truck associated with a food truck option may be identified on a digital map so that the customer can readily view the distance of each food truck from the user's customer device. In certain embodiments, the displaying may be performed and/or facilitated by utilizing the first user device 102, the second user device 111, the server 140, the server 150, the server 160, the communications network 136, the external network 165, the database 155, the vehicle 115, any appropriate program, device, network, and/or process of the system 100, or a combination thereof.

At step 210, the method 200 may include enabling the customer device to access the food truck profiles of the businesses associated with the food truck options. In certain embodiments, the enabling may be performed and/or facilitated by utilizing the first user device 102, the second user device 111, the server 140, the server 150, the server 160, the communications network 136, the external network 165, the database 155, the vehicle 115, any appropriate program, device, network, and/or process of the system 100, or a combination thereof. At step 212, the method 200 may include enabling the customer device to place an order for a service and/or product provided by one or more businesses associated with the food truck options via the graphical user interface of the software application. For example, the first user 101 may place an order for a food item offered by a business associated with a particular food truck option by utilizing the first user device 102 to make the order via the application. In certain embodiments, the placing of the order may be performed and/or facilitated by utilizing the first user device 102, the second user device 111, the server 140, the server 150, the server 160, the communications network 136, the external network 165, the database 155, the vehicle 115, any appropriate program, device, network, and/or process of the system 100, or a combination thereof.

At step 214, the method 200 may include determining and/or displaying a status associated with the service and/or product ordered by the customer. For example, if a food item is ordered, the system 100 may determine that the food item is currently in the process of being cooked by an operator of the vehicle 115 belonging to the business associated with the food truck option. The application may display the status to the user via the graphical user interface of the application. In certain embodiments, the determining and/or displaying may be performed and/or facilitated by utilizing the first user device 102, the second user device 111, the server 140, the server 150, the server 160, the communications network 136, the external network 165, the database 155, the vehicle 115, any appropriate program, device, network, and/or process of the system 100, or a combination thereof. At step 216, the method 200 may include facilitating providing of the service and/or product to the customer associated with the customer device that ordered the product and/or service. In certain embodiments, this may entail providing notifications to the customer device via the application indicating that the food item ordered is ready to be picked up by the customer and is located at a certain designated area of the vehicle 115. In certain embodiments, the providing of the service and/or product may be performed and/or facilitated by utilizing the first user device 102, the second user device 111, the server 140, the server 150, the server 160, the communications network 136, the external network 165, the database 155, the vehicle 115, any appropriate program, device, network, and/or process of the system 100, or a combination thereof. At step 218, the method 200 may include enabling the customer to receive an incentive for making the order, to provide feedback on the service or product, and/or to perform any other suitable actions. For example, the application may enable the user to provide feedback relating to the food item ordered, obtain points towards obtaining a free food item on a subsequent occasion, place an additional order, book the vehicle 115 for a private event, and/or perform other actions. Notably, the method 200 may further incorporate any of the features and functionality described for the system 100 or as otherwise described herein.

Notably, the system 100 and/or method 200 may include additional functionality and features. In certain embodiments, the software application may enable customers to view the locations of the vehicles 115 associated with food truck options in real time on a map via the graphical user interface of the application. In certain embodiments, the locations of the vehicles 115 may be adjusted in real time as the user and the user's computing device move around in an environment. In certain embodiments, the businesses associated with the food truck options may be configured to provide future locations of the vehicles 115 associated with the food truck options over a given period of time, such as, for example, 7 days in advance. In certain embodiments, the provider of the application may require that the business and vehicle 115 be located at the locations that they specified for their future locations. In certain embodiments, customers may have the ability to book a vehicle 115 of a food truck option for catering, private events, weddings, birthday parties, and the like. In certain embodiments, customers can rate their experiences with a business, vote on their favorite menu items, leave commentary and/or feedback for other customers via the application, as well as message the operators of the vehicles 115 and/or businesses via the application. In certain embodiments, the businesses/vendors associated with a vehicle 115 may be required to commit to a fee subscription with the provider of the application for a given period of time, such as month-to-month or yearly or another desired time period. In certain embodiments, the businesses/vendors may be provided with a customer vendor's graphical user interface that may be tailored to the particular business. The customers may also have their own tailored graphical user interface for the application suited to their preferences.

In certain embodiments, the businesses may be required to create a food truck profile for their business and the food truck option displayed on the application. The profile may include a menu, pictures of food items, wait times, schedules of operation of the vehicle 115 and/or business, an amount of people in line at the vehicle 115 to order food, an availability of food items, reviews on the food items and/or business, pricing information, trending and popular items and/or services, a popularity of the business, an identification of which customers have checked into their business, such as via the application, any other information, or a combination thereof. In certain embodiments, use of the application may be free to the customer and the customer's may not be required to create a user profile. However, if the customer does create a user profile, the application may provide them with the opportunity to obtain additional benefits. For example, the application may enable the customer to save their favorite food truck businesses in their profile, receiving push notifications for nearby food trucks, have the ability to communicate with the food truck vendors directly, have a rewards system (e.g. points system) for future discounts with participating businesses/vendors, as well as social media integration for third party applications. In certain embodiments, the user profile may include the customer's name, preferences, address information, payment information, username and password information, purchase history information, any other information, or a combination thereof.

In certain embodiments, the systems and methods may incorporate the ability for a supply and demand function via the application. For example, geo-analytics information may be shared with the application, which includes information that is associated with the locations of the customers, searches conducted by customers via the application, activity conducted by customers via the application, queries made by the customers, user profile information, and/or their preferences. Such information may be utilized by the application to assist the businesses to forecast where to locate their vehicles 115 during particular times of day or days of the week. In certain embodiments, the customers may earn money or rewards after checking into a particular food truck option through the application a threshold number of times. In certain embodiments, when a customer checks into a food truck option via the application when they reach the vehicle 115 associated with the food truck option, the customer pay be provided with the option to purchase a product or service with a pre-loaded credit card (or other payment mechanism) so that the vehicle 115 or a computing device can scan a quick response code or other code to verify that the customer was at the vehicle 115. Once the customer has checked in a threshold number of times, the customer may be given a reward, for example. In certain embodiments, if a particular customer regularly orders a threshold frequency from a particular business, the application may transmit notifications and/or deals to a customer even if the customer is outside a threshold distance from the vehicle 115.

In certain embodiments, the application may suggest alternative food truck options if the customer is a threshold distance away from a preferred food truck option that the customer regularly orders from. The alternative food truck options may have a similar menu to the preferred food truck option and/or have some similarity to the preferred food truck option. In certain embodiments, the application may enable a customer to place a pre-order for a product or service before going to the vehicle 115, and based on the customer's device location with respect to the vehicle 115 location, the application may execute the order and have the food items prepared at an appropriate time so that the customer's wait time at the vehicle 115 is reduced. In certain embodiments, if a customer does not know what to order or what food truck option they want, the customer may be provided suggestions with multiple different food types to select from, and the customer may be able to refresh the suggestions at any desired time interval or on demand. In certain embodiments, one or more suggestions may come from a favorite category, one or more suggestions may come from a category that the customer is familiar with, and one or more suggestions may come from a random food truck category. In certain embodiments, the application may provide suggestions based on weather preferences specified by a customer in her user profile, and the application may even integrate with a weather application to provide recommendations to where the vehicle 115 should be located to avoid adverse weather. Additionally, the application may factor in sea level information to provide recommendations as to where to locate the vehicle 115 as well. Furthermore, the application may determine which customers order which food items and may recommend that the vendors/businesses locate their trucks closer to customers that typically order their type of food items. In certain embodiments, the application can analyze demand for various time periods and may determine patterns associated with demand for products. Based on the analysis, the application may recommend that the vendor/business adjust inventory for certain time periods and/or locations to account for such demand changes.

In certain embodiments, the application may provide a social calendar, which may allow customers to schedule a time to meet with other customers at a vehicle 115 of a particular food option. The application may also provide forecasting around particular holidays, religious holidays, or events as well. Such forecasting may be utilized to generate recommendations for locating a vehicle 115 at an optimal location for success for the business. The application may also generate a proposed cross-country trip for the vehicle 115 and the business based on forecasting. The routing on a map may be automatically generated so that each stop along the route presents a good opportunity for the business to generate sales and connect with an optimal number of customers. In certain embodiments, the application may determine where events are being held and may recommend to the business to relocate their vehicles 115 in proximity to locations associated with such events. Data that powers the recommendations generated by the application may be crowdsourced via other applications, such as via third party API integration with such applications, which may provide customer data and preferences to the application. In certain embodiments, when a vehicle 115 runs out of ingredients and/or supplies, the application may provide a check-off list to refill the ingredients and/or supplies in the application itself. The application can track inventory and integrate with supplier applications and/or devices to automatically reorder ingredients and/or supplies (e.g. propane, tires, gas, etc.) for the vehicle 115 and/or business.

The systems and methods disclosed herein may include further functionality and features. For example, the operative functions of the system 100 and method may be configured to execute on a special-purpose processor specifically configured to carry out the operations provided by the system 100 and method. Notably, the operative features and functionality provided by the system 100 and method may increase the efficiency of computing devices that are being utilized to facilitate the functionality provided by the system 100 and method 200. For example, through the use of the devices, components, programs, and/or networks of the system 100, machine learning and/or artificial intelligence capabilities may be utilized so as to reduce the amount of computer operations need to be performed by the devices in the system 100 using the processors and memories of the system 100 than in systems that are not capable of machine learning as described in this disclosure. In such a context, less processing power needs to be utilized because the processors and memories do not need perform analyses and operations that have already been learned by the system 100. As a result, there may be substantial savings in the usage of computer resources by utilizing the software, functionality, methodologies, and algorithms provided in the present disclosure.

Notably, in certain embodiments, various functions and features of the system 100 and methods may operate without human intervention and may be conducted entirely by computing devices, robots, and/or processes. For example, in certain embodiments, multiple computing devices may interact with the vehicle 115 of the system 100 to provide the functionality supported by the system 100. Additionally, in certain embodiments, the computing devices of the system 100 may operate continuously to reduce the possibility of errors being introduced into the system 100. In certain embodiments, the system 100 and methods may also provide effective computing resource management by utilizing the features and functions described in the present disclosure. For example, in certain embodiments, when analyzing location data, input data, and/or any other data traversing the system 100, any selected device in the system 100 may transmit a signal to a computing device receiving or processing the data that only a specific quantity of computer processor resources (e.g. processor clock cycles, processor speed, processor cache, etc.) may be dedicated to processing the data, generating outputs based on the data, performing any other operation conducted by the system 100, or any combination thereof. For example, the signal may indicate an amount of processor cycles of a processor that may be utilized to process location data, and/or specify a selected amount of processing power that may be dedicated to processing the location data or any of the other operations performed by the system 100. In certain embodiments, a signal indicating the specific amount of computer processor resources or computer memory resources to be utilized for performing an operation of the system 100 may be transmitted from the vehicle 115 and/or the first and/or second user devices 102, 111 to the various components and devices of the system 100.

In certain embodiments, any device in the system 100 may transmit a signal to a memory device to cause the memory device to only dedicate a selected amount of memory resources to the various operations of the system 100. In certain embodiments, the system 100 and methods may also include transmitting signals to processors and memories to only perform the operative functions of the system 100 and methods at time periods when usage of processing resources and/or memory resources in the system 100 is at a selected, predetermined, and/or threshold value. In certain embodiments, the system 100 and methods may include transmitting signals to the memory devices utilized in the system 100, which indicate which specific portions (e.g. memory sectors, etc.) of the memory should be utilized to store any of the data utilized or generated by the system 100. Notably, the signals transmitted to the processors and memories may be utilized to optimize the usage of computing resources while executing the operations conducted by the system 100. As a result, such features provide substantial operational efficiencies and improvements over existing technologies.

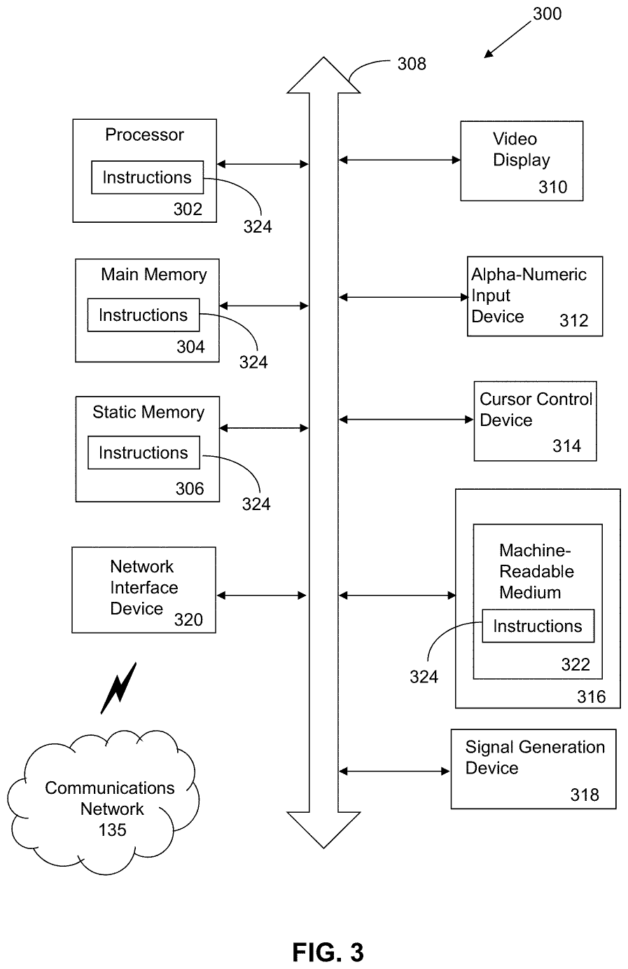

Referring now also to FIG. 3, at least a portion of the methodologies and techniques described with respect to the exemplary embodiments of the system 100 can incorporate a machine, such as, but not limited to, computer system 300, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine may operate as a standalone device. In some embodiments, the machine may be connected (e.g., using communications network 135, the external network 165, another network, or a combination thereof) to and assist with operations performed by other machines, programs, functions, and systems, such as, but not limited to, the first user device 102, the second user device 111, the server 140, the server 150, the database 155, the server 160, the external network 165, the computing device 170, the vehicle 115, the communications network 135, any device, system, and/or program in FIGS. 1-3, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310, which may be, but is not limited to, a liquid crystal display (LCD), a flat panel, a solid state display, or a cathode ray tube (CRT). The computer system 300 may include an input device 312, such as, but not limited to, a keyboard, a cursor control device 314, such as, but not limited to, a mouse, a disk drive unit 316, a signal generation device 318, such as, but not limited to, a speaker or remote control, and a network interface device 320.

The disk drive unit 316 may include a machine-readable medium 322 on which is stored one or more sets of instructions 324, such as, but not limited to, software embodying any one or more of the methodologies or functions described herein, including those methods illustrated above. The instructions 324 may also reside, completely or at least partially, within the main memory 304, the static memory 306, or within the processor 302, or a combination thereof, during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 322 containing instructions 324 so that a device connected to the communications network 135, the external network 165, another network, or a combination thereof, can send or receive voice, video or data, and communicate over the communications network 135, the external network 165, another network, or a combination thereof, using the instructions. The instructions 324 may further be transmitted or received over the communications network 135, the external network 165, another network, or a combination thereof, via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system, comprising:
a memory that stores instructions; and
a processor that executes the instructions to perform operations, the operations comprising:
providing a food truck option via a graphical user interface of an application;
providing, via the application, a location of a vehicle associated with the food truck option to a customer device accessing the application, wherein the location of the vehicle is provided via a global positioning sensor in proximity to the vehicle;
displaying, via the graphical user interface, the location of the vehicle associated with the food truck option on a map where locations of other vehicles associated with other food truck options are displayed; and
enabling the customer device to access a food truck profile of the food truck option that includes content associated with the food truck option.

2. The system of claim 1, wherein the operations further comprise sharing the location of the vehicle associated with the vehicle via a smartphone including the global positioning sensor that is in proximity to the vehicle.

3. The system of claim 1, wherein the operations further comprise sharing the location of the vehicle associated with the food truck option via the global positioning sensor of the vehicle itself.

4. The system of claim 1, wherein the operations further comprise enabling the customer device to make an order for a food item provided by a business associated with the vehicle and the food truck option.

5. The system of claim 1, wherein the operations further comprise displaying a menu, pricing information, food truck information, business information, a review, or a combination thereof, when the food truck profile of the food truck option is accessed by the customer device.

6. The system of claim 1, wherein the operations further comprise displaying the location of the vehicle relative to the locations of the other vehicles associated with the other food truck options on the map in real time as a customer device location of the customer device changes in real time.

7. The system of claim 1, wherein the operations further comprise enabling a user of the customer device to book the food truck option and the vehicle for a selected period of time.

8. The system of claim 1, wherein the operations further comprise providing, via the application, future locations of the vehicle associated with the food truck option over a period of time.

9. The system of claim 1, wherein the operations further comprise enabling a user associated with the customer device to provide feedback, a review, commentary, or a combination thereof, associated with the food truck option via the application.

10. The system of claim 1, wherein the operations further comprise providing an update relating to the food truck option, wherein the update comprises an update to a menu of the food truck option, an update to pricing of a food item of the menu, an update to the location of the vehicle, an update to information associated with the food truck option, an update associated with a business associated with the food truck option, an update relating to an amount of demand for services provided by the business, an update relating to future locations for the vehicle associated with the food truck option, an update relating to an availability of the food time, an update relating to a weather condition in an environment in which the vehicle is located, an update relating to a booking of the vehicle, any other update, or a combination thereof.

11. The system of claim 1 wherein the operations further comprise enabling third party application programming interface integration with the application.

12. The system of claim 1, wherein the operations further comprise displaying a wait time for a user of the customer device to obtain an order of a food item.

13. The system of claim 1, wherein the operations further comprise initiating preparation of a food item ordered via the application based on a current customer device location of the customer device of a user.

14. A method, comprising:
providing, by utilizing instructions from a memory that are executed by a processor, a food truck option via a graphical user interface of an application;
providing, via the application, a location of a vehicle associated with the food truck option to a customer device accessing the application, wherein the location of the vehicle is provided via a global positioning sensor in proximity to the vehicle;
displaying, via the graphical user interface, the location of the vehicle associated with the food truck option on a map where locations of other vehicles associated with other food truck options are displayed; and
enabling the customer device to access a food truck profile of the food truck option that includes content associated with the food truck option.

15. The method of claim 14, further comprising receiving a signal indicating expected future locations of a plurality of customer devices including the customer device.

16. The method of claim 15, further comprising setting an optimal future location of the vehicle associated with the food truck option based on the expected future locations of the plurality of customer devices.

17. The method of claim 14, further comprising enabling the application to provide an alternate food truck option if the food truck option is unavailable to the customer device.

18. The method of claim 14, further comprising enabling a user of the customer device to establish a user profile including preferences associated with food items, locations, pricing, weather conditions, or a combination thereof, preferred by the user.

19. The method of claim 14, further comprising forecasting demand for a business associated with the food truck option based on aggregated data from a plurality of customer devices including the customer device that have ordered from the business.

20. A non-transitory computer-readable device comprising instructions, which when executed by a processor, cause the processor to perform operations, the operations comprising:
providing a food truck option via a graphical user interface of an application;
providing, via the application, a location of a vehicle associated with the food truck option to a customer device accessing the application, wherein the location of the vehicle is provided via a global positioning sensor in proximity to the vehicle;
displaying, via the graphical user interface, the location of the vehicle associated with the food truck option on a map where locations of other vehicles associated with other food truck options are displayed; and
enabling the customer device to access a food truck profile of the food truck option that includes content associated with the food truck option.
